(19) United States
(12) Patent Application Publication
(10) Pub. No.: US 2006/0054750 A1
(43) Pub. Date: Mar. 16, 2006

(54) Support device in a plasma display

(75) Inventor: Jing-Lin Zhang, Chu-Nan (TW)

Correspondence Address: BRUCE H. TROXELL, SUITE 1404, 5205 LEESBURG PIKE, FALLS CHURCH, VA, 22041, US

(73) Assignee: Coretronic Corporation

(21) Appl. No.: 11/158,055

(22) Filed: Jun. 22, 2005

(30) Foreign Application Priority Data
Sep. 14, 2004 (TW) 93214644

(51) Int. Cl. F16M 11/00; A47F 5/00

(52) U.S. Cl. 248/122.1

(57) ABSTRACT

A support device includes a base member formed with an opening and a retention flange extending downwardly from the periphery defining the opening; a tubular sleeve extending upwardly from the base member and having a lower portion that is inserted into the opening in the base member and formed with a hook engaging the retention flange; and a holding post disposed within the tubular sleeve, and including an upper holding end exposed from the tubular sleeve and a lower enlarged end with a cross section greater than that of the upper holding end such that the lower enlarged end forcibly presses the lower portion of the tubular sleeve to abut against the retention flange of the base member in order to immobilize the holding post with respect to the tubular sleeve and consequently securing the tubular sleeve on the base member.

### FIELD OF THE INVENTION

The invention relates to a support device, more particularly to a support device in a plasma display.

### BACKGROUND OF THE INVENTION

Plasma displays are becoming more and more appreciated by the consumers, since they occupy a smaller amount of space in the drawing room when compared to CRT displays. Plasma displays have smaller thickness and a relatively small amount of weight when compared to other displays. Plasma displays are usually hung on a wall of the drawing room or supported by a stand on the ground.

Referring to FIG. 1, a plasma display 2 includes a display panel 10 (generally flat) and an outer casing 12 surrounding and extending rearward from the display panel 10. The outer casing 12 can be disposed on a cabinet by means of a conventional support device 4. The conventional support device 4 generally includes a base member 8 and a holding post 6. The base member 8 includes an upper plate 802 formed with a through hole and a lower plate 804. The holding post 6 has a lower portion fastened securely to the lower plate 804 and an upper portion extending through the through hole in the upper plate 802 for holding the outer casing 12.

In order to burden the weight of the outer casing 12, the holding post 6 is generally made of metal. Since the intermediate portion of the holding post 6 is usually exposed to the exterior of the outer casing 12, the externally presence of the holding post 6 affects the aesthetic appearance of the plasma display 2 due to contrast colors between the outer casing 12 and the post 6.

Referring to FIG. 2, in order to improve the aforesaid disadvantage, a reinforcing tubular sleeve 806 is integrally formed with the upper plate 802 so as to enclose and conceal the post 6 once the upper and lower plates 802, 804 are assembled together to form the base member 8. However, the tubular sleeve 806 may be ruined due to accidental collision during the transportation, since the former cannot be detached from the upper plate 802.

### SUMMARY OF THE INVENTION

The main object of the present invention is to provide a support device for supporting a display panel of the plasma display. The support device has a simple structure and is cleared of the aforesaid disadvantage resulting from use of the conventional support device.

A support device is provided according to the present invention for a plasma display that includes a display panel. The support device accordingly includes: a base member having an upper surface formed with an opening, an inner periphery confining the opening, and a retention flange extending downwardly from the inner periphery; a hollow tubular sleeve mounted on the base member to extend upwardly therefrom and having a lower portion that is inserted into the opening in the base member and formed with a hook engaging the retention flange so as to prevent upward removal of the tubular sleeve from the base member; and a holding post disposed within the tubular sleeve, and including an upper holding end exposed from an upper end of the tubular sleeve for holding the display panel thereon and a lower enlarged end that is disposed below the upper surface of the base member and has a cross section greater than that of the upper holding end for the lower enlarged end to forcibly presses the lower portion of the tubular sleeve to abut against the retention flange of the base member in order to immobilize the holding post with respect to the tubular sleeve and consequently securing the tubular sleeve on the base member.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates how a conventional support device supports a display panel thereon;

FIG. 2 is an exploded and fragmentary view of the conventional support device of FIG. 1;

FIG. 3A is a front view of the preferred embodiment of a support device according to the present invention for supporting a display panel thereon;

FIG. 3B is an exploded view of the preferred embodiment of the support device according to the present invention;

FIG. 4A is a top planar view of the base member employed in the support device according to the present invention;

FIG. 4B is a cross-sectional view of the base member taken along the line IV-IV in FIG. 4A;

FIG. 5 is a fragmentary side view of a hollow tubular sleeve employed in the support device according to the present invention;

FIG. 6 is a partly sectional view the support device of the present invention;

FIG. 7 is a fragmentary sectional view of the support device of the present invention;

FIG. 8 is an exploded view of a modified support device of the present invention; and

FIG. 9 illustrates a back view illustrating how the support device of the present invention supports a display panel thereon.

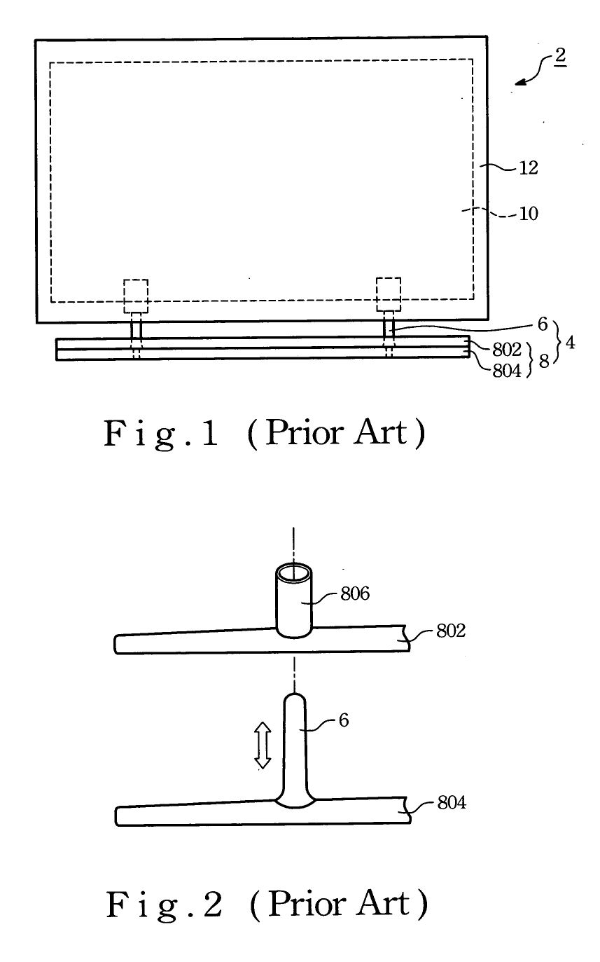

### DETAILED DESCCRIPTIONS OF THE PREFERRED EMBODIMENTS

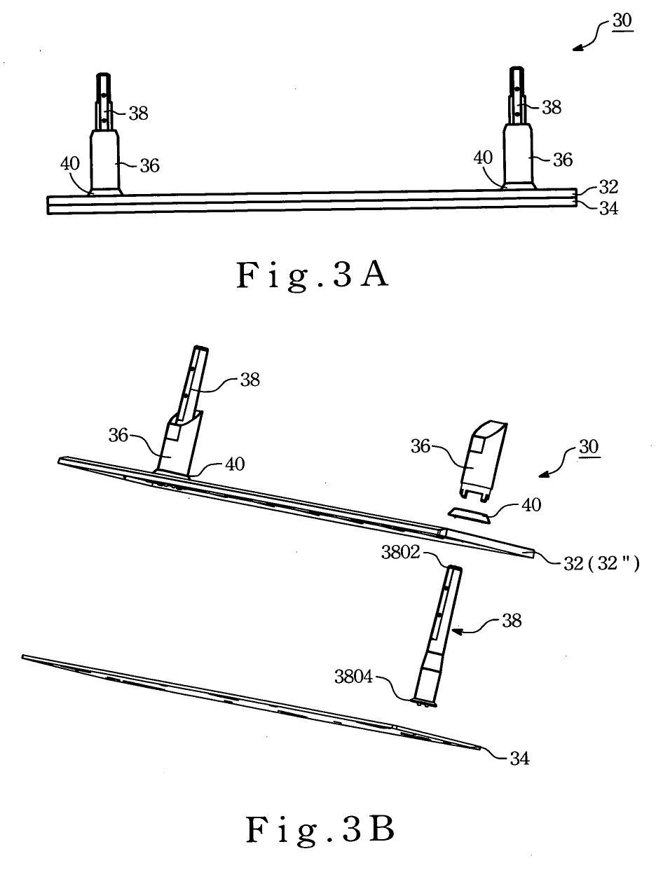

Referring to FIGS. 3 to 5, the preferred embodiment of a support device 30 of the present invention is shown and is used for supporting a display panel of a plasma display. The support device 30 includes a base member 32, two hollow tubular sleeves 36, two holding posts 38 and two reinforcing seats 40.

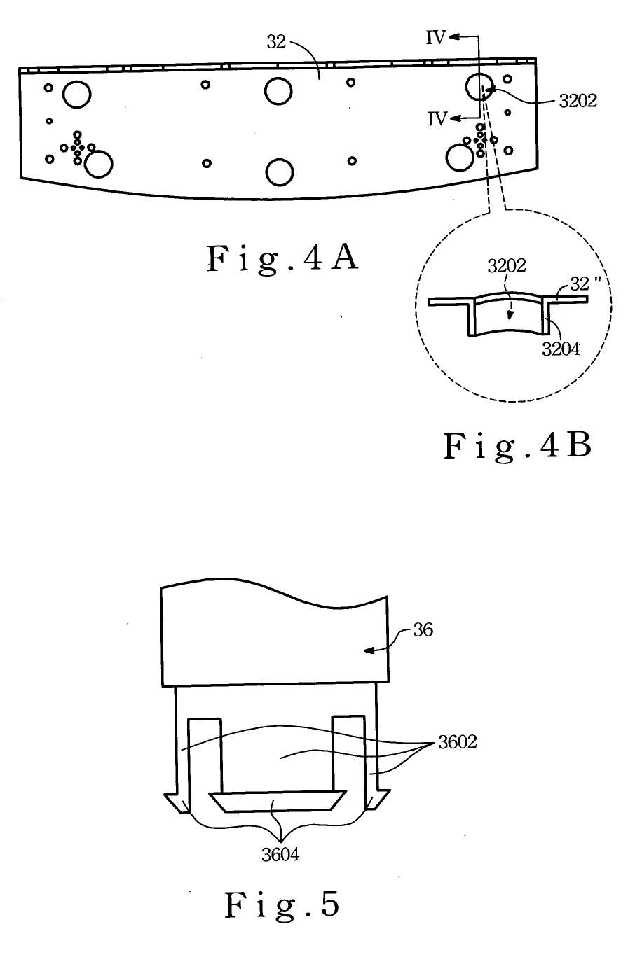

As illustrated, the base member 32 includes an upper plate 32″ (see FIG. 6) and a bottom plate 34 disposed below and coupled to the upper plate 32″ to formed a gap therebetween. The upper plate 32″ has an upper surface formed with an opening 3202, an inner periphery confining the opening 3202, and a retention flange 3204 (see FIG. 4B) extending downwardly from the inner periphery of the upper plate 32″ into the gap. Preferably, the upper and lower plates 32″, 34 are made of metal.

Each of the hollow tubular sleeve 36 is made of plastic material and mounted on the upper plate 32″ to extend upwardly therefrom, and has a lower portion 3602 that is inserted into the opening 3202 (see FIG. 6) in the upper plate 32″ and that is formed with a hook 3604 engaging the retention flange 3204 so as to prevent upward removal of the tubular sleeve 36 from the upper plate 32″. In order to provide resiliency so as to facilitate insertion of the lower portion 3602 of the tubular sleeve 36 into the opening 3202, the lower portion 3602 is preferably formed with a plurality of open-end slots extending upwardly from the periphery defining the lowermost end of the lower portion 3602. Each of the tubular sleeves 36 has an upper portion with a cross section greater than that of the lower portion 3602 so as to define an abutment shoulder 3606 therebetween, the utility of which will be explained in the following paragraphs.

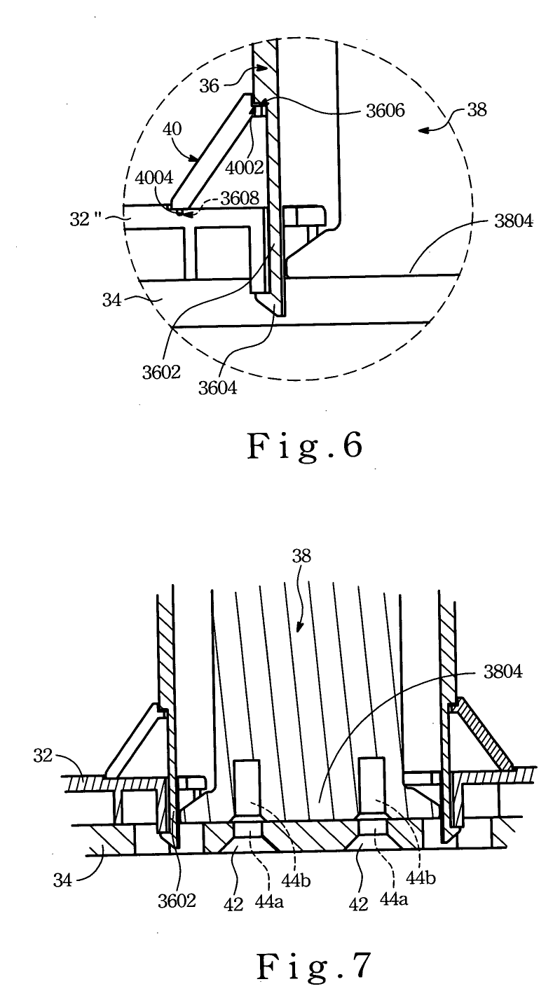

Each of the holding post 38 is disposed within the tubular sleeve 36, and includes an upper holding end 3802 exposed from an upper end of the tubular sleeve 36 for holding the display panel (not shown) thereon, and a lower enlarged end 3804 that is disposed below the upper surface of the upper plate 32″ (see FIG. 6) and that has a cross section greater than the upper holding end 3802 such that the lower enlarged end 3804 is seated securely on the bottom plate 34. Under this condition, the lower enlarged end 3804 of the holding post 38 forcibly presses the lower portion 3602 of the tubular sleeve 36 to abut against the retention flange 3204 of the upper plate 32, thereby immobilizing the holding post 38 with respect to the tubular sleeve 36 and consequently securing the tubular sleeves 36 on the upper plate 32″. In order to further strengthen the position of the holding post 38, two fastening screws 42 extend through the screw holes (44a) in the bottom plate 34 and engage the threaded holes (44b) in the holding post 38 (see FIG. 7).

Referring to FIG. 6, note that the upper plate 32″ further has a plurality of recesses 3608 formed in the upper surface circumferentially around the opening 3202. Each of the reinforcing seats 40 is truncated cone-shaped and is disposed on the upper plate 32″ surrounding the respective tubular sleeve 26, and has a constricted upper end and an enlarged lower end opposite to the constricted upper end. The constricted upper end of the reinforcing seat 40 is formed with an inwardly, and radially extending flange 4002 that supports the abutment shoulder 3606 of the tubular sleeve 36 while the enlarged lower end thereof is formed with a plurality of downwardly extending positioning stubs 4004 respectively extending into the recesses 3608 in the upper plate 32″, thereby securely seating the reinforcing seat 40 on the upper plate 32″ and consequently strengthening the rigidity of the tubular sleeves 36. Preferably, the reinforcing seat 40 is electroplated in order to provide an external aesthetic appearance and to prevent corrosion.

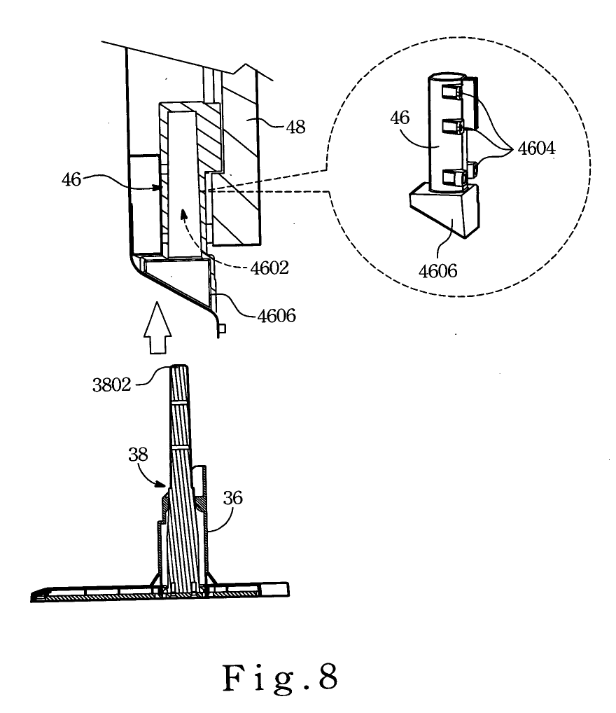

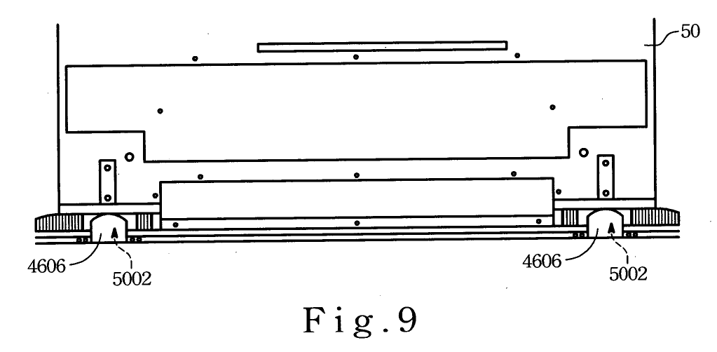

Referring to FIG. 8, a modified support device of the present invention is shown to have the structure similar to the previous embodiment. The only difference resides in that the modified support device includes two coupler members 46. Each of the coupler members 46 is a hollow body defining a post-receiving space 4602 to permit extension of the upper end 3802 of the respective holding post 38. The hollow body is formed with a plurality of screw holes 4604 into which several fastener screws (not shown) extend for securing the display panel 48 on the coupler members 46. Each of the coupler members 46 has a lower shielding portion 4606 which covers the passages 5002 formed in the outer casing 50 (see FIG. 9), thereby providing electromagnetic interference effect to the display panel 48. Since the structure of the display panel 48 is not the relevant feature of the present invention, a detailed description thereof is omitted herein for the sake of brevity.

The support device of the present invention is simple in structure but provides a relatively strong strength to support the display panel 46 of the plasma TV set thereon. In addition, the aesthetic appearance thereof is also improved by virtue of concealing the holding post 38 within the tubular sleeve 36 and presence of the reinforcing seats 40.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A support device in a plasma display, the plasma display including a display panel, the support device comprising:
a base member having an upper surface formed with an opening, an inner periphery confining said opening, and a retention flange extending downwardly from said inner periphery;
a hollow tubular sleeve mounted on said base member to extend upwardly therefrom and having a lower portion, said lower portion being inserted into said opening in said base member and being formed with a hook engaging said retention flange so as to prevent upward removal of said tubular sleeve from said base member; and
a holding post disposed within said tubular sleeve and including an upper holding end exposed from an upper end of said tubular sleeve for holding the display panel thereon and a lower enlarged end disposed below said upper surface of said base member with a cross section greater than the cross section of said upper holding end for said lower enlarged end to forcibly press said lower portion of said tubular sleeve to abut against said retention flange of said base member in order to immobilize said holding post with respect to said tubular sleeve and consequently securing said tubular sleeve on said base member.

2. The support device according to claim 1, further comprising a bottom plate disposed below and spaced apart from said base member by a gap therebetween, said lower enlarged end of said holding post being disposed within said gap and seated securely on said bottom plate.

3. The support device according to claim 1, further comprising a coupler member mounted on said upper holding end of said holding post and adapted to be coupled to the display panel for holding the display panel thereon.

4. The support device according to claim 3, wherein the display panel further includes an outer casing surrounding the display panel and having a lower body formed with a passage, said coupler member being disposed externally of said outer casing and concealing said passage.

5. The support device according to claim 4, wherein said coupler member is made of metal.

6. The support device according to claim 1, wherein said tubular sleeve includes an upper portion defining said upper end with a cross section greater than the cross section of said lower portion for defining an abutment shoulder therebetween, the support device further comprising a reinforcing seat disposed on said base member surrounding said tubular sleeve and having a constricted upper end formed with an inwardly and radially extending flange supporting said abutment shoulder of said tubular sleeve in order to enhance mounting of said tubular sleeve on said base member.

7. The support device according to claim 6, wherein said base member has a plurality of recesses formed in said upper surface circumferentially around said opening, said reinforcing seat having an enlarged lower end opposite to said constricted upper end and being formed with a plurality of downwardly extending positioning stubs respectively extending into said recesses in said base member, thereby securely seating said reinforcing seat on said base member.

8. The support device according to claim 7, wherein said reinforcing seat is electroplated to prevent corrosion.

9. The support device according to claim 1, wherein said holding post is made of metal and the tubular sleeve is made of plastic material.
